(19) United States
(12) Patent Application Publication
(10) Pub. No.: US 2025/0371418 A1
(43) Pub. Date: Dec. 4, 2025

(54) TRAINER PAIRING METHOD IN FEDERATED LEARNING MODEL TRAINING, ELECTRONIC DEVICE, AND STORAGE MEDIUM

(71) Applicant: Beijing Volcano Engine Technology Co., Ltd., Beijing (CN)

(72) Inventors: Qingyou YANG, Beijing (CN); Junjie SHI, Beijing (CN); Keyu YANG, Beijing (CN); Yang LIU, Beijing (CN); Jue Hong, Beijing (CN); Ye WU, Beijing (CN)

(21) Appl. No.: 19/052,135

(22) Filed: Feb. 12, 2025

(30) Foreign Application Priority Data
May 31, 2024 (CN) 202410704094.4

(51) Int. Cl. G06N 20/00; G06F 16/242

(52) U.S. Cl. CPC G06N 20/00; G06F 16/2428

(57) ABSTRACT

The present disclosure relates to a trainer pairing method in federated learning model training, an electronic device, and storage medium. The method includes: obtaining, after the first trainer is started, a trainer number of the first trainer from a counter component; querying trainer numbers of a second participant in the counter component, and taking a second trainer corresponding to a target number as a pairing trainer of the first trainer when the target number being the same as the trainer number of the first trainer exists in the trainer numbers of the second participant; wherein the first trainer and the second trainer are configured to perform model training collaboratively in a federated learning process, and trainers started by the first participant and the second participant are numbered according to a same rule.

### CROSS-REFERENCE TO RELATED APPLICATION

This application claims the priority to and benefits of the Chinese Patent Application, No. 202410704094.4, which was filed on May 31, 2024. The aforementioned patent application is hereby incorporated by reference in its entirety.

### TECHNICAL FIELD

The present disclosure relates to a trainer pairing method in federated learning model training, an electronic device, and a storage medium.

### BACKGROUND

Vertical federated learning is a privacy protection machine learning paradigm, which can combine data from multiple participants to perform secure machine learning training tasks. In a large-scale vertical federated learning scenario, taking two participants as an example, both participants will start a large number of trainers at the same time, and the trainers of both participants need to be paired in pairs.

In the related art, a manual pairing manner is usually adopted, that is, a mapping pairing table of trainers of both participants is manually created. However, manual pairing is inefficient and time-consuming, resulting in reduced timeliness of the model, and prone to problems of repeated pairing or missing pairing, which makes the training data entered into the trainers unable to be aligned and causes abnormal training indicators.

### SUMMARY

This Summary is provided to introduce concepts in a simplified form that are described in detail in the following Detailed Description. This Summary is not intended to identify key features or essential features of the claimed technical solutions, nor is it intended to be used to limit the scope of the claimed technical solutions.

In a first aspect, the present disclosure provides a trainer pairing method in federated learning model training, applied to a first trainer of a first participant, where the method includes:
obtaining, after the first trainer is started, a trainer number of the first trainer from a counter component; and
querying trainer numbers of a second participant in the counter component, and taking a second trainer corresponding to a target number as a pairing trainer of the first trainer when the target number being the same as the trainer number of the first trainer exists in the trainer numbers of the second participant,
wherein the first trainer and the second trainer are configured to perform model training collaboratively in a federated learning process, and trainers started by the first participant and the second participant are numbered according to a same rule.

In a second aspect, the present disclosure provides a trainer pairing apparatus in federated learning model training, applied to a first trainer of a first participant, where the apparatus includes:
an obtaining module, configured to obtain, after the first trainer is started, a trainer number of the first trainer from a counter component; and
a pairing module, configured to query trainer numbers of a second participant in the counter component, and take a second trainer corresponding to a target number as a pairing trainer of the first trainer when the target number being the same as the trainer number of the first trainer exists in the trainer numbers of the second participant,
wherein the first trainer and the second trainer are configured to perform model training collaboratively in a federated learning process, and trainers started by the first participant and the second participant are numbered according to a same rule.

In a third aspect, the present disclosure provides a computer-readable medium storing a computer program thereon, where when the computer program is executed by a processing apparatus, the steps of the method according to any one of the above first aspect are implemented.

In a fourth aspect, the present disclosure provides an electronic device, including:
a storage apparatus storing a computer program stored thereon; and
a processing apparatus, configured to execute the computer program in the storage apparatus to implement the steps of the method according to any one of the above first aspect.

In a fifth aspect, the present disclosure provides a computer program product, including a computer program, where when the computer program is executed by a processor, the steps of the method according to any one of the above first aspect are implemented.

Other features and advantages of the present disclosure will be described in detail in the following detailed description.

### BRIEF DESCRIPTION OF DRAWINGS

The above and other features, advantages and aspects of the embodiments of the present disclosure become more apparent with reference to the following detailed description and in conjunction with accompany drawings. Throughout the accompany drawings, same or similar reference numerals refer to same or similar elements. It should be understood that the accompany drawings are schematic and that the components and elements are not necessarily drawn to scale. In the accompany drawings:

FIG. 1 is a schematic diagram of a process of performing data alignment by vertical federated learning according to an exemplary embodiment of the present disclosure;

FIG. 2 is a flowchart of a trainer pairing method in federated learning model training according to an exemplary embodiment of the present disclosure;

FIG. 3 is a schematic diagram of a process of trainer pairing according to an exemplary embodiment of the present disclosure;

FIG. 4 is a schematic diagram of collaborative control according to an exemplary embodiment of the present disclosure;

FIG. 5 is a schematic diagram of trainer pairing and collaborative control based on a distributed collaborative component according to an exemplary embodiment of the present disclosure;

FIG. 6 is a schematic diagram of timing of trainer pairing and collaborative control based on a distributed collaborative component according to an exemplary embodiment of the present disclosure;

FIG. 7 is a block diagram of a trainer pairing apparatus in federated learning model training according to an exemplary embodiment of the present disclosure; and

FIG. 8 is a schematic diagram of a structure of an electronic device according to an exemplary embodiment of the present disclosure.

### DETAILED DESCRIPTION

The embodiments of the present disclosure will be described in more detail below with reference to the accompany drawings. Although some embodiments of the present disclosure are shown in the drawings, it should be understood that the present disclosure can be implemented in various forms, and should not be construed as being limited to the embodiments set forth herein; rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that various steps described in the method implementations of the present disclosure may be performed in a different order and/or in parallel. In addition, method implementations may include additional steps and/or omit performing the illustrated steps. The scope of the present disclosure is not limited in this respect.

As used herein, the term “include” and its variants are open-ended inclusions, that is, “include but not limited to”. The term “based on” is “at least partially based on”. The term “one embodiment” represents “at least one embodiment”. The term “another embodiment” represents “at least one another embodiment”. The term “some embodiments” represents “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifications of “one” and “a plurality of” mentioned in the present disclosure are schematic rather than restrictive, and those skilled in the art should understand that unless the context clearly indicates otherwise, it should be understood as “one or more”.

The names of messages or information exchanged between a plurality of apparatuses in the implementations of the present disclosure are only used for illustrative purposes, and are not used to limit the scope of these messages or information.

It can be understood that, before using the technical solutions disclosed in the embodiments of the present disclosure, the user should be informed of the type, scope of use, use scenarios, etc. of the personal information involved in the present disclosure and obtain the user's authorization in an appropriate manner in accordance with relevant laws and regulations.

For example, in response to receiving an active request from the user, prompt information is sent to the user to explicitly prompt the user that the operation requested to be performed will require the acquisition and use of the user's personal information. In this way, the user can autonomously select whether to provide personal information to software or hardware such as an electronic device, an application, a server or a storage medium that performs the operation of the technical solution of the present disclosure according to the prompt information.

As an optional but not limiting implementation, the manner of sending the prompt information to the user in response to receiving the active request from the user may be, for example, a pop-up window, and the prompt information may be presented in the pop-up window in a text form. In addition, the pop-up window may also carry a selection control for the user to select “agree” or “disagree” to provide personal information to the electronic device.

It can be understood that the above process of notifying and acquiring user authorization is only schematic, and does not constitute a limitation to the implementations of the present disclosure, and other manners that satisfy relevant laws and regulations may also be applied to the implementations of the present disclosure.

At the same time, it can be understood that the data involved in the technical solution (including but not limited to the data itself, acquisition or use of data) should comply with requirements of corresponding laws, regulations and related provisions.

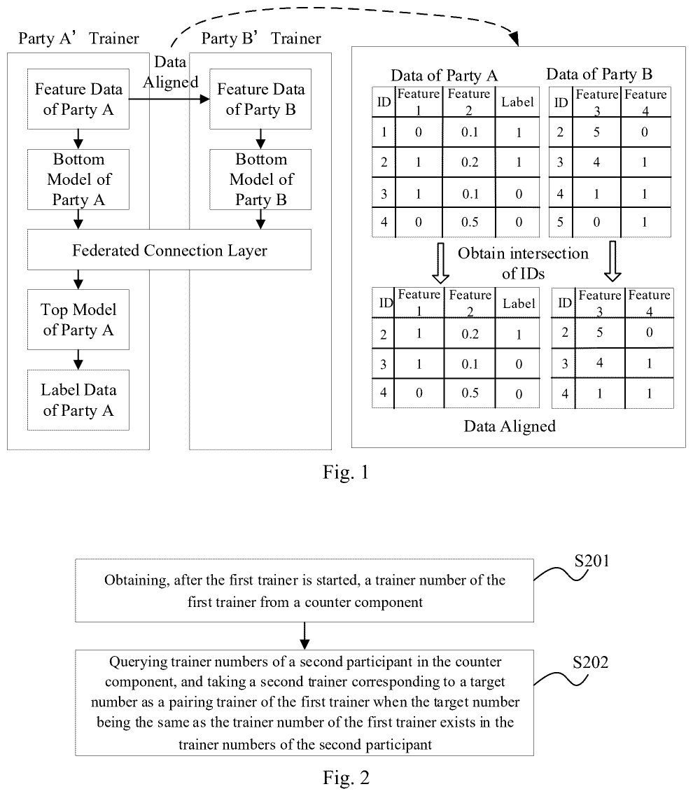

In vertical federated learning, features of training data for model training is distributed among multiple participants, and one of the participants holds a label at the same time. Taking two-party stand-alone vertical federated learning between Party A and Party B as an example, as shown in FIG. 1, data alignment is first performed on training data of Party A and Party B, that is, data with a same ID identifier is aligned. For example, Party A is Company A, Party B is Company B, Company A and Company B provide different services to users respectively, and there are some overlapping users between two companies, then the ID identifier is a user ID, and performing data alignment on the feature data of Company A and Company B is equivalent to acquiring feature data of the overlapping users in Company A and Company B, respectively. Aligned training data is input into trainers of both parties for model training. In a training process, the trainers of both parties will exchange data (forward and backward propagation of model) through a federated connection layer. Moreover, in all training processes, training data of both parties needs to be kept in an aligned state, otherwise the training will be disordered and the training accuracy will be abnormal.

In the two-party stand-alone vertical federated learning scenario, data alignment is relatively simple. However, in practical applications, it is necessary to face an ultra-large-scale data and ultra-long-time training process, and stand-alone training cannot satisfy the requirements in terms of actual performance and stability, so distributed multi-machine parallel training needs to be performed, and at the same time, due to high real-time requirements for the model in some scenarios, the model needs to be trained online for a long time.

Therefore, in the large-scale vertical federated learning scenario, both parties will start a large number of trainers at the same time, that is, perform two-party multi-machine vertical federated learning model training, so it is necessary to pairwise pair the trainers of both parties in pairs. After pairing is completed, the training can continue in the original manner. In the related art, a manual pairing manner is usually adopted, that is, a mapping pairing list of trainers of both parties is manually created, both parties obtain information of paired parties from the mapping pairing table respectively, and communicate with each other with this information.

However, pairwise pairing should first ensure consistency, that is, no repeated pairing (one trainer cannot be paired with multiple trainers of the other party) or missing pairing. If the pairing does not satisfy the consistency, the training data entered into the trainers cannot be aligned, resulting in abnormal training indicators. Secondly, manual pairing is inefficient and time-consuming, resulting in reduced timeliness of the model.

At the same time, in a long-time training, it is inevitable to encounter a situation where a trainer exits unexpectedly, such as machine failure, migration, and maintenance. When a trainer of one party exits unexpectedly, how to efficiently and collaboratively exit the paired trainer is also a problem to be solved urgently.

In view of this, the present disclosure provides a trainer pairing method and apparatus in federated learning model training, and an electronic device to solve the above technical problems. It should be noted that the trainer pairing method in federated learning model training provided by the present disclosure can be applied to a large-scale vertical federated learning scenario, and each participant may have a distributed structure, that is, each participant includes a plurality of trainers.

The embodiments of the present disclosure will be further explained and described below with reference to the accompany drawings. For ease of description, a model training of two-party vertical federated learning between Party A and Party B is used as an example for description. In practical applications, it can be applied to model training of vertical federated learning with any quantity of parties.

FIG. 2 is a flowchart of a trainer pairing method in federated learning model training according to an exemplary embodiment of the present disclosure. Referring to FIG. 2, the method is applied to a first trainer of a first participant, and includes the following steps.

S201, obtaining, after the first trainer is started, a trainer number of the first trainer from a counter component.

S202, querying trainer numbers of a second participant in the counter component, and taking a second trainer corresponding to a target number as a pairing trainer of the first trainer when the target number being the same as the trainer number of the first trainer exists in the trainer numbers of the second participant.

The first trainer and the second trainer are configured to perform model training collaboratively in a federated learning process, and trainers started by the first participant and the second participant are numbered according to a same rule.

With the above method, first, a trainer obtains its own number after the trainer is started, trainers of the first participant and the second participant are numbered according to a same rule, and then the trainers with a same number of both participants are token as paired trainers, and the paired trainers can perform model training collaboratively in the federated learning process. In this way, automatic pairing of trainers participating in the federated learning model training is realized, pairing efficiency is improved, and time-consuming of pairing is reduced, which in turn improves timeliness of the model, and can avoid the problem of repeated pairing or missing pairing of trainers, so that training data entered into the trainers can be aligned, and the normal training indicators are ensured.

In a possible implementation, a quantity of trainers started by the first participant is equal to a quantity of trainers started by the second participant.

In a possible implementation, S201 may include: sending, after the first trainer is started, a registration request to the counter component, so that the counter component takes a registration sequence number of the first trainer as the trainer number of the first trainer in response to the registration request; and obtaining the trainer number of the first trainer from the counter component.

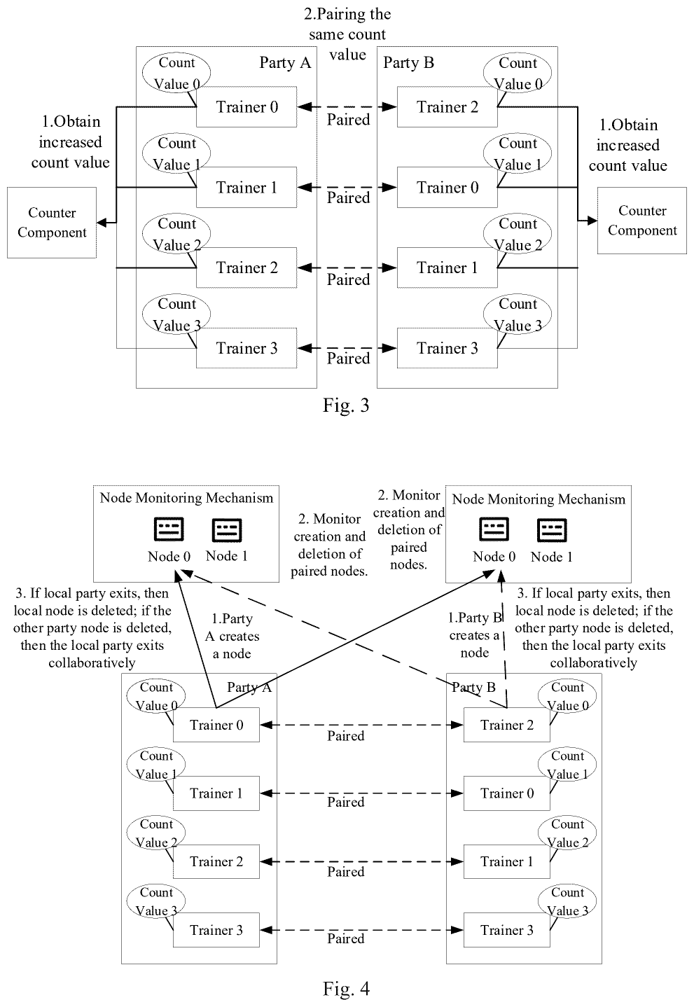

Exemplarily, as shown in FIG. 3, after the trainer is started, a count value is obtained from the counter component. The counter component may be a distributed counter, which may be determined according to requirements, and it is only necessary to realize a counting function, which is not limited by the present disclosure. It should be understood that count values obtained by the two-party trainers participating in the vertical federated learning model training have a same starting value and a same increasing rule, for example, the count values all start from 0 and increase one by one, which is not limited by the present disclosure, and it is only necessary to ensure that the trainers of both parties are numbered according to a same rule.

In a possible implementation, a first number list including trainer numbers of the first participant and a second number list including the trainer numbers of the second participant are stored in the counter component, wherein the trainer numbers of the first participant are determined by the counter component in response to registration requests of trainers of the first participant, and the trainer numbers of the second participant are determined by the counter component in response to registration requests of trainers of the second participant.

Exemplarily, the counter component can separately store trainer numbers of a plurality of participants in response to registration requests sent by trainers of the plurality of participants. Accordingly, when a trainer exits the model training, an exit request can be sent to the counter component, and the counter component deletes the number of the trainer in the number list. By managing the trainer numbers through the number list, it is convenient to maintain and update the trainer numbers of the plurality of participants and perform subsequent pairing and collaborative control of the trainers.

In a possible implementation, querying the trainer numbers of the second participant in the counter component includes: querying the second number list in the counter component through a number query interface to obtain the trainer numbers of the second participant, wherein the number query interface is an interface provided by the counter component for querying a trainer number.

Exemplarily, the counter component can provide an interface for querying a trainer number, and the first trainer can query the second number list in the counter component through the number query interface to obtain the trainer numbers of the second participant, and then determine its own paired trainer according to the trainer numbers of the second participant. Correspondingly, the second trainer can also query the first number list in the counter component through the number query interface to obtain trainer numbers of the first participant, and then determine its own paired trainer according to the trainer numbers of the first participant.

Further, trainers with the same count value constitute a group of paired trainers, and subsequent communication between the paired trainers can be performed based on the count value. In a possible manner, the method further includes: determining a communication channel based on the trainer number of the first trainer, so as to send a message to the second trainer through the communication channel.

Exemplarily, taking an execution of a training task job_id_0 as an example, if a trainer 2 of Party A wants to send a message to a paired trainer of Party B (that is, a trainer 1 of Party B), it can send a message to Topic (which can be understood as a communication channel) “/job_id_0/B/2” of the communication component, and then the trainer 1 of Party B receives the message from the Topic “/job_id_0/B/2” of the communication component.

It should be noted that pairing process of the present disclosure does not require interaction between both parties, and only simple interactions with the counter component are required. The counter component can be deployed in an electronic device that can interact with the first participant and the second participant, which is not limited by the present disclosure. Since the counter component can ensure strong consistency, the trainer pairing based on the counter component can also ensure consistency. Even in the case where thousands of trainers are paired at the same time, there will be no situation of repeated pairing of trainers or missing pairing of trainers, thereby realizing efficient and stable trainer pairing.

In a possible implementation, the method further includes: querying the trainer numbers of the second participant in the counter component, and when no number being the same as the trainer number of the first trainer exists in the trainer numbers of the second participant and a number greater than the trainer number of the first trainer exists in the trainer numbers of the second participant, determining to exit the model training.

Exemplarily, when a number obtained by the trainer of the first participant is 4, if the trainer numbers of the second participant does not include 4, and there is a number 5 that is greater than the number 4 is included in the second participant, it indicates that a trainer in the second participant has obtained the number 4 after being started, but may have exited the model training and deleted the number 4 due to a failure or other reasons before pairing. Then, the trainer numbered 4 in the first participant can collaboratively exit the model training, so as to restart to obtain a new number, and then determine a new paired trainer to participate in the model training, thereby realizing efficient collaborative control of the trainers of both parties.

In a possible implementation, the method further includes: querying the trainer numbers of the second participant in the counter component, and when no number being the same as the trainer number of the first trainer exists in the trainer numbers of the second participant and no number greater than the trainer number of the first trainer exists in the trainer numbers of the second participant, continuing to query an new added trainer number of the second participant; and determining whether to exit the model training according to the new added trainer number.

Exemplarily, when a number obtained by the trainer of the first participant is 4, if trainer numbers of the second participant does not include 4, and there is no number greater than the number 4 is included in the second participant, the new added number of the trainer in the second participant can be continuously queried, and whether to exit the model training is determined according to the new added number.

It should be understood that with the authorization of the other party, the addition and deletion of a number of the other party's trainer, etc. can be monitored through a monitoring mechanism, and a number of a trainer is independent of the training data, which can ensure data privacy and security.

In a possible implementation, determining whether to exit the model training according to the new added number may include: when the new added trainer number being the same as the trainer number of the first trainer, taking a third trainer corresponding to the new added trainer number as the pairing trainer of the first trainer, wherein the first trainer and the third trainer are configured to perform the model training collaboratively in the federated learning process; and when the new added trainer number is different from the trainer number of the first trainer and the new added trainer number is greater than the trainer number of the first trainer, determining to exit the model training.

Exemplarily, taking a number obtained by the trainer of the first participant is 4 and numbers obtained by the trainers of the second participant includes 0, 1, 2 and 3 as an example, if a newly started trainer X of the second participant obtains the number of 4, it indicates that when a trainer numbered 4 in the first participant obtains this number, the trainer X in the second participant has not been started yet, and the trainers numbered 4 of both parties can be token as a group of paired trainers.

Alternatively, if a newly started trainer X of the second participant obtains a number of 5, it indicates that a trainer in the second participant has obtained the number of 4, but may have exited the model training and deleted the number of 4 due to a failure or other reasons before pairing. Then, a trainer numbered 4 in the first participant can collaboratively exit the model training, so as to restart to obtain a new number, and then determine a new paired trainer to participate in the model training, thereby realizing efficient collaborative control of the trainers of both parties.

It should be understood that if a number deletion event can be monitored before pairing, for example, the number obtained by the trainer of the first participant is 4, and it is monitored that a trainer numbered 4 in the second participant has exited the model training, then the trainer numbered 4 in the first participant can collaboratively exit the model training.

In a possible implementation, the method further includes: querying, after taking the second trainer corresponding to the target number as the pairing trainer of the first trainer, an operation event triggered by the second trainer in the counter component through an event query interface, wherein the event query interface is an interface provided by the counter component for querying an operation event of a trainer; and when a number deletion event or a session loss event triggered by the second trainer is queried, determining to exit the model training.

Exemplarily, after the pairing is successful, the number deletion event or the session loss event of the paired trainer of the other party can be monitored based on a monitoring mechanism with the authorization of the other party. The number deletion event represents that the other party's trainer exits the model training, and the session loss event represents that the other party's trainer does not respond. If the number deletion event or the session loss event of the other party's trainer is monitored, the local trainer can collaboratively exit the model training, thereby realizing efficient collaborative control of the trainers of both parties.

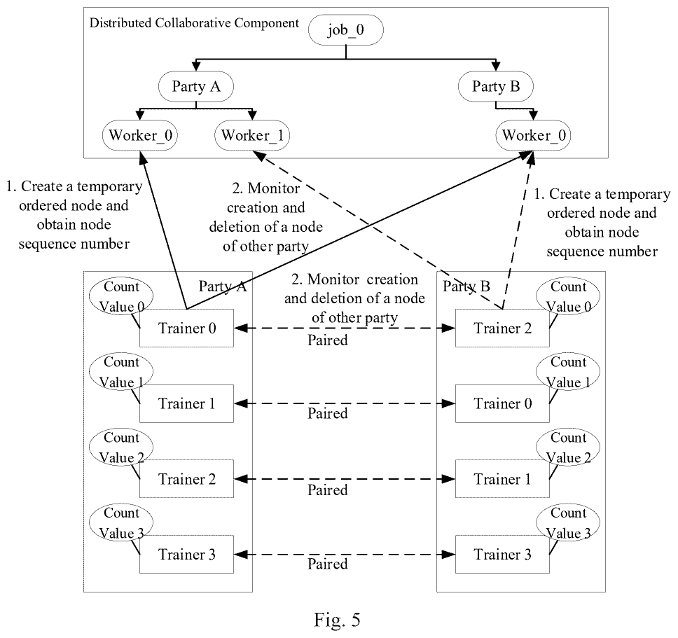

Exemplarily, with the node monitoring mechanism, the trainers can monitor each other to sense the state of the other party's trainer, so as to realize collaborative training of distributed trainers. As shown in FIG. 4, after the trainer pairing is successful, a local node is created, and a node identification path uses its own count value, for example, “/{job_id}/{role}/{count_value}”. For example, for a training task job_0, a trainer of Party A with a count value of 0 can use/job_0/A/0 to represent the node identification path of the trainer.

Furthermore, the node corresponding to the paired trainer of the other party is monitored, and since the trainers with the same count value are paired, a node path of the other party's node can be determined based on its own count value. If a trainer corresponding to the local node 0 exits the model training, the node 0 created by the local party is deleted, and if the deletion event of the other party's node 0 is monitored, the trainer corresponding to the local node 0 exits collaboratively. In this way, when a node of one party exits, the other party of the pairing can also perceive it in time, thereby realizing fast and stable collaborative control.

With the above method, the trainer pairing for model training in large-scale vertical federated learning can be realized based on the counter component. The two-party trainers obtain the increasing and unique (referring to the uniqueness in the local party) count values from the counter component respectively, and two trainers with equal count values automatically form a paired trainer. Based on the node monitoring mechanism, the collaborative control of the trainer for model training in large-scale vertical federated learning is realized, that is, each trainer creates a node representing its own state, and the local trainer realizes the collaborative control by monitoring the state of the paired node.

In a possible implementation, functions of the above counter component and monitoring mechanism can be realized by using distributed application coordination service software with both a distributed counter and a monitoring mechanism, which is hereinafter referred to as a distributed collaborative component for short. The distributed collaborative component can create an ordered node, the ordered node has an increasing and unique sequence number, and events such as node creation, node deletion, and child node transform can be monitored. The trainer pairing and collaborative control of vertical federated learning based on the distributed collaborative component will be described below by taking the execution of the training task job_0 by the trainers of Party A and Party B as an example.

As shown in FIG. 5, after a local trainer is started, an ordered node is created for the distributed collaborative component, and an order value of the node is obtained as a count value, that is, the number of the trainer. For ease of description, it is assumed that the count value corresponding to the trainer is 0, and the ordered node is represented by worker_0. The local trainer can query whether ordered nodes created by the other party in the distributed collaborative component has a worker_0 node through an interface, and if it exists, the pairing is successful.

Alternatively, if the ordered nodes created by the other party does not have the worker_0 node, it is further queried whether a trainer corresponding to the other party's worker_0 node exits the model training, and if it has exited, the trainer corresponding to the local worker_0 node is controlled to also exit collaboratively, thereby realizing collaborative control before pairing.

Exemplarily, if the other party's worker_0 node does not exist and there is other node with a larger sequence number, it indicates that the trainer corresponding to the other party's worker_0 node has exited the model training, and then the trainer corresponding to the local worker_0 node is controlled to also exit collaboratively. Alternatively, if the other party's worker_0 node does not exist and there are no other node with the larger sequence number, a transform condition of a sub-node under/job_0/B is monitored by the monitoring mechanism of the distributed collaborative component, and if there is a new added node and a sequence number of the new added node is greater than a sequence number of the worker_0 node, it indicates that the trainer corresponding to the other party's worker_0 node has exited the model training, and then the trainer corresponding to the local worker_0 node is controlled to also exit collaboratively. Alternatively, if a creation event of the other party's worker_0 node is monitored, trainers corresponding to the worker_0 nodes of both parties are token as a group of paired trainers.

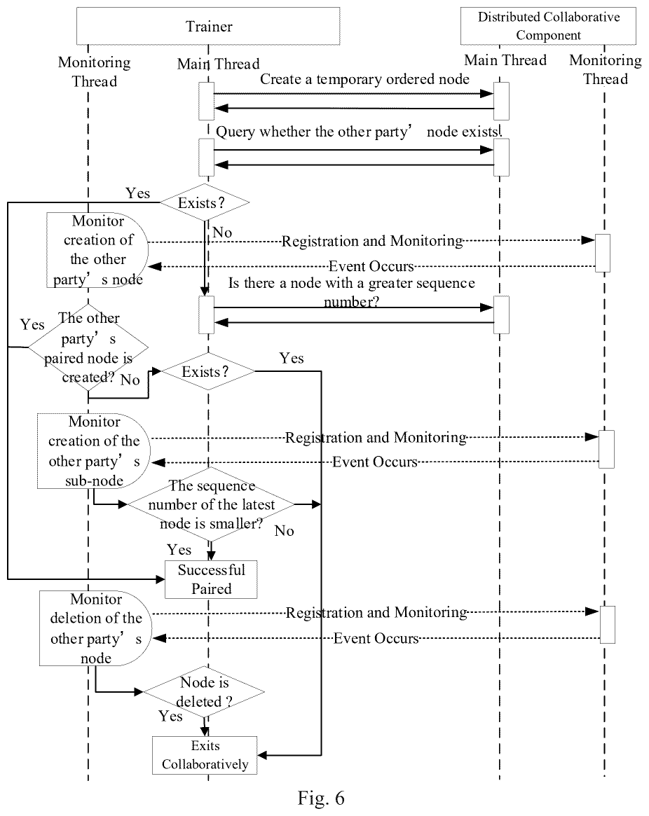

Further, after the pairing is successful, an additional thread is started in the background to monitor the node deletion event or the session loss event of the other party's node. If the node deletion event or the session loss event occurs, the trainer corresponding to the local corresponding node is controlled to exit the model training, thereby realizing the collaborative control after pairing. The above dynamic interaction process of trainer pairing and collaborative control of vertical federated learning model training based on the distributed collaborative component can be referred to FIG. 6.

It should be noted that the implementations of the above distributed collaborative component are not limited in the embodiments of the present disclosure. The distributed counter and the node monitoring mechanism can be realized by Zookeeper at the same time, or the distributed counter can be realized by redis, mysql, etc., and the node monitoring mechanism can be realized by etcd, consul and other components, which can be determined according to requirements.

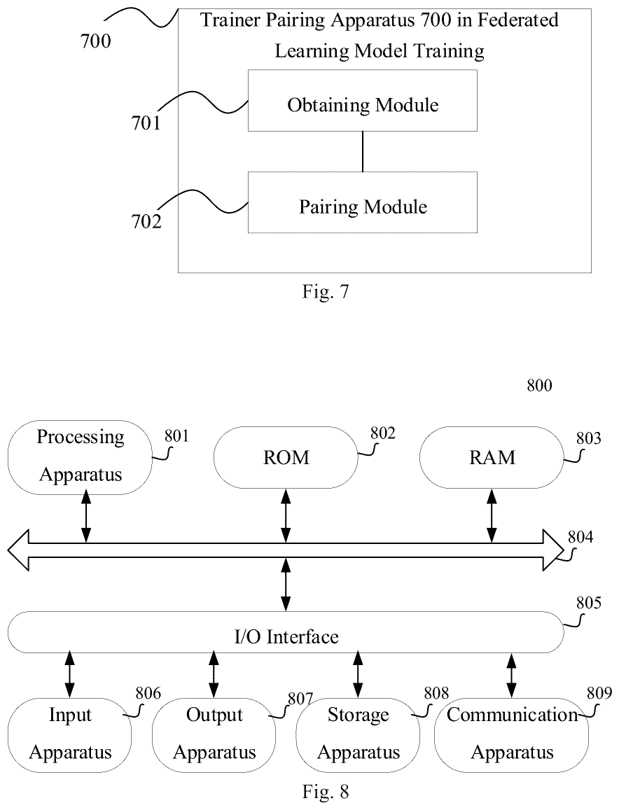

Based on the same concept, an embodiment of the present disclosure further provides a trainer pairing apparatus in federated learning model training. As shown in FIG. 7, the trainer pairing apparatus 700 in federated learning model training is applied to a first trainer of a first participant, and includes:
an obtaining module 701, configured to obtain, after the first trainer is started, a trainer number of the first trainer from a counter component; and
a pairing module 702, configured to query trainer numbers of a second participant in the counter component, and take a second trainer corresponding to a target number as a pairing trainer of the first trainer when the target number being the same as the trainer number of the first trainer exists in the trainer numbers of the second participant,
wherein the first trainer and the second trainer are configured to perform model training collaboratively in a federated learning process, and trainers started by the first participant and the second participant are numbered according to a same rule.

With the above apparatus, first, a trainer obtains its own number after the trainer is started, trainers of the first participant and the second participant are numbered according to a same rule, and then the trainers with a same number of both participants are token as paired trainers, and the paired trainers can perform model training collaboratively in the federated learning process. In this way, automatic pairing of trainers participating in the federated learning model training is realized, pairing efficiency is improved, and time-consuming of pairing is reduced, which in turn improves timeliness of the model, and can avoid the problem of repeated pairing or missing pairing of trainers, so that training data entered into the trainers can be aligned, and the normal training indicators are ensured.

Optionally, the trainer pairing apparatus 700 in the federated learning model training further includes:
a first determining module, configured to the trainer numbers of the second participant in the counter component, and when no number being the same as the trainer number of the first trainer exists in the trainer numbers of the second participant and no number greater than the trainer number of the first trainer exists in the trainer numbers of the second participant, continue to query an new added trainer number of the second participant; and
a first controlling module, configured to determine whether to exit the model training according to the new added trainer number.

Optionally, the first controlling module is configured to:
when the new added trainer number being the same as the trainer number of the first trainer, take a third trainer corresponding to the new added trainer number as the pairing trainer of the first trainer, wherein the first trainer and the third trainer are configured to perform the model training collaboratively in the federated learning process; and
when the new added trainer number is different from the trainer number of the first trainer and the new added trainer number is greater than the trainer number of the first trainer, determine to exit the model training.

Optionally, the trainer pairing apparatus 700 in the federated learning model training further includes:
a second controlling module, configured to query the trainer numbers of the second participant in the counter component, and when no number being the same as the trainer number of the first trainer exists in the trainer numbers of the second participant and a number greater than the trainer number of the first trainer exists in the trainer numbers of the second participant, determine to exit the model training.

Optionally, the trainer pairing apparatus 700 in the federated learning model training further includes:
a second determining module, configured to query, after taking the second trainer corresponding to the target number as the pairing trainer of the first trainer, an operation event triggered by the second trainer in the counter component through an event query interface, wherein the event query interface is an interface provided by the counter component for querying an operation event of a trainer; and
a third controlling module, configured to when a number deletion event or a session loss event triggered by the second trainer is queried, determine to exit the model training.

Optionally, the obtaining module 701 is configured to:
send, after the first trainer is started, a registration request to the counter component, so that the counter component takes a registration sequence number of the first trainer as the trainer number of the first trainer in response to the registration request; and
obtain the trainer number of the first trainer from the counter component.

Optionally, first number list including trainer numbers of the first participant and a second number list including the trainer numbers of the second participant are stored in the counter component, wherein the trainer numbers of the first participant are determined by the counter component in response to registration requests of trainers of the first participant, and the trainer numbers of the second participant are determined by the counter component in response to registration requests of trainers of the second participant.

Optionally, the pairing module 702 is configured to:
query the second number list in the counter component through a number query interface to obtain the trainer numbers of the second participant, wherein the number query interface is an interface provided by the counter component for querying a trainer number.

Optionally, the trainer pairing apparatus 700 in the federated learning model training further includes:
a third determining module, configured to determine a communication channel based on the trainer number of the first trainer, so as to send a message to the second trainer through the communication channel.

With regard to the apparatus in the above embodiments, the specific manners in which the individual modules perform operations have been described in detail in the embodiments related to the method, and will not be described in detail here.

Based on the same concept, an embodiment of the present disclosure further provides a computer-readable medium storing a computer program thereon, where when the computer program is executed by a processing apparatus, the steps of the trainer pairing method in federated learning model training are implemented.

Based on the same concept, an embodiment of the present disclosure further provides an electronic device, which may include:
a storage apparatus storing a computer program thereon; and
a processing apparatus, configured to execute the computer program in the storage apparatus to implement the steps of the trainer pairing method in federated learning model training.

Based on the same concept, an embodiment of the present disclosure further provides a computer program product, including a computer program, where when the computer program is executed by a processor, the steps of the trainer pairing method in federated learning model training are implemented.

Referring to FIG. 8 below, it illustrates a schematic diagram of a structure of an electronic device 800 suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), and a vehicle terminal (such as a vehicle navigation terminal), and a fixed terminal such as a digital TV and a desktop computer. The electronic device shown in FIG. 8 is only an example, and should not bring any limitation to the function and use scope of the embodiments of the present disclosure.

As shown in FIG. 8, the electronic device 800 may include a processing apparatus (such as a central processing unit, a graphics processor, etc.) 801, which may perform various appropriate actions and processing according to a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, the ROM 802, and the RAM 803 are connected to each other through a bus 804. An input/output (I/O) interface 805 is also connected to the bus 804.

Generally, the following apparatus may be connected to the I/O interface 805: an input apparatus 806, including, for example, a touch screen, a touchpad, a keyboard, a mouse, a camera, a microphone, an accelerometer, a gyroscope, etc.; an output apparatus 807, including, for example, a liquid crystal display (LCD), a speaker, a vibrator, etc.; a storage apparatus 808, including, for example, a magnetic tape, a hard disk, etc.; and a communication apparatus 809. The communication apparatus 809 may allow the electronic device 800 to perform wireless or wired communication with other devices to exchange data. Although FIG. 8 shows the electronic device 800 with various apparatuses, it should be understood that it is not required to implement or have all the illustrated apparatuses. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program contains program codes for executing the method shown in the flowchart. In such an embodiment, the computer program may be downloaded and installed from the network through the communication apparatus 809, or installed from the storage apparatus 808, or installed from the ROM 802. When the computer program is executed by the processing apparatus 801, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, a computer-readable storage medium may be any tangible medium containing or storing a program, and the program may be used by or in conjunction with an instruction execution system, apparatus, or device. In the present disclosure, a computer-readable signal medium may include a data signal propagated in a baseband or as a part of a carrier wave, which carries computer-readable program codes. Such propagated data signals may take a variety of forms, including but not limited to electromagnetic signals, optical signals, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes contained on the computer-readable medium may be transmitted by any suitable medium, including but not limited to: electric wires, optical cables, RF (radio frequency), etc., or any suitable combination thereof.

In some implementations, any currently known or future-developed network protocol such as HTTP (HyperText Transfer Protocol) can be used for communication, and can be interconnected with digital data communication (e.g., communication network) in any form or medium. Examples of communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device, or may exist alone without being assembled into the electronic device.

The above computer-readable medium carries one or more programs, and when the one or more programs are executed by the electronic device, the electronic device is caused to: obtain, after the first trainer is started, a trainer number of the first trainer from a counter component; and query trainer numbers of a second participant in the counter component, and take a second trainer corresponding to a target number as a pairing trainer of the first trainer when the target number being the same as the trainer number of the first trainer exists in the trainer numbers of the second participant, wherein the first trainer and the second trainer are configured to perform model training collaboratively in a federated learning process, and trainers started by the first participant and the second participant are numbered according to a same rule.

The computer program codes for performing the operations of the present disclosure may be written in one or more programming languages or a combination thereof. The above programming languages include but are not limited to object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a special purpose hardware-based system that performs the specified functions or operations, or may also be implemented by a combination of special purpose hardware and computer instructions.

The modules involved in the embodiments described in the present disclosure may be implemented in software or hardware. The name of the module does not constitute a limitation to the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof.

The above description is only preferred embodiments of the present disclosure and an explanation of the applied technical principles. Those skilled in the art should understand that the disclosure scope involved in the present disclosure is not limited to the technical solution formed by the specific combination of the above technical features, but should also cover other technical solutions formed by any combination of the above technical features or their equivalent features without departing from the above disclosed concept. For example, a technical solution formed by replacing the above features with technical features with similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Likewise, while the above discussion contains several specific implementation details, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only exemplary forms of implementing the claims. With regard to the apparatus in the above embodiments, the specific manners in which the individual modules perform operations have been described in detail in the embodiments related to the method, and will not be described in detail here.

1. A trainer pairing method in federated learning model training, applied to a first trainer of a first participant, wherein the method comprises:
obtaining, after the first trainer is started, a trainer number of the first trainer from a counter component; and
querying trainer numbers of a second participant in the counter component, and taking a second trainer corresponding to a target number as a pairing trainer of the first trainer when the target number being a same as the trainer number of the first trainer exists in the trainer numbers of the second participant,
wherein the first trainer and the second trainer are configured to perform model training collaboratively in a federated learning process, and trainers started by the first participant and the second participant are numbered according to a same rule.

2. The method according to claim 1, further comprising:
querying the trainer numbers of the second participant in the counter component, and when no number being the same as the trainer number of the first trainer exists in the trainer numbers of the second participant and no number greater than the trainer number of the first trainer exists in the trainer numbers of the second participant, continuing to query a new added trainer number of the second participant; and
determining whether to exit the model training according to the new added trainer number.

3. The method according to claim 2, wherein determining whether to exit the model training according to the new added trainer number comprises:
when the new added trainer number being the same as the trainer number of the first trainer, taking a third trainer corresponding to the new added trainer number as the pairing trainer of the first trainer, wherein the first trainer and the third trainer are configured to perform the model training collaboratively in the federated learning process; and
when the new added trainer number is different from the trainer number of the first trainer and the new added trainer number is greater than the trainer number of the first trainer, determining to exit the model training.

4. The method according to claim 1, wherein the method further comprises:
querying the trainer numbers of the second participant in the counter component, and when no number being the same as the trainer number of the first trainer exists in the trainer numbers of the second participant and a number greater than the trainer number of the first trainer exists in the trainer numbers of the second participant, determining to exit the model training.

5. The method according to claim 1, wherein the method further comprises:
querying, after taking the second trainer corresponding to the target number as the pairing trainer of the first trainer, an operation event triggered by the second trainer in the counter component through an event query interface, wherein the event query interface is an interface provided by the counter component for querying an operation event of a trainer; and
when a number deletion event or a session loss event triggered by the second trainer is queried, determining to exit the model training.

6. The method according to claim 1, wherein obtaining, after the first trainer is started, the trainer number of the first trainer from the counter component comprises:
sending, after the first trainer is started, a registration request to the counter component, so that the counter component takes a registration sequence number of the first trainer as the trainer number of the first trainer in response to the registration request; and
obtaining the trainer number of the first trainer from the counter component.

7. The method according to claim 1, wherein a first number list comprising trainer numbers of the first participant and a second number list comprising the trainer numbers of the second participant are stored in the counter component, wherein the trainer numbers of the first participant are determined by the counter component in response to registration requests of trainers of the first participant, and the trainer numbers of the second participant are determined by the counter component in response to registration requests of trainers of the second participant.

8. The method according to claim 7, wherein querying the trainer numbers of the second participant in the counter component comprises:
querying the second number list in the counter component through a number query interface to obtain the trainer numbers of the second participant, wherein the number query interface is an interface provided by the counter component for querying a trainer number.

9. The method according to claim 1, further comprising:
determining a communication channel based on the trainer number of the first trainer, so as to send a message to the second trainer through the communication channel.

10. An electronic device, comprising:
at least a processor, and
a non-transitory memory with instructions thereon,
wherein the instructions upon execution by the processor, cause the processor to:
obtain, after a first trainer is started, a trainer number of the first trainer from a counter component; and
query trainer numbers of a second participant in the counter component, and take a second trainer corresponding to a target number as a pairing trainer of the first trainer when the target number being a same as the trainer number of the first trainer exists in the trainer numbers of the second participant, wherein the first trainer and the second trainer are configured to perform model training collaboratively in a federated learning process, and trainers started by the first participant and the second participant are numbered according to a same rule.

11. The electronic device according to claim 10, wherein the processor is further caused to:
query the trainer numbers of the second participant in the counter component, and when no number being the same as the trainer number of the first trainer exists in the trainer numbers of the second participant and no number greater than the trainer number of the first trainer exists in the trainer numbers of the second participant, continue to query a new added trainer number of the second participant; and
determine whether to exit the model training according to the new added trainer number.

12. The electronic device according to claim 11, wherein when determining whether to exit the model training according to the new added trainer number, the processor is further caused to:
when the new added trainer number being the same as the trainer number of the first trainer, take a third trainer corresponding to the new added trainer number as the pairing trainer of the first trainer, wherein the first trainer and the third trainer are configured to perform the model training collaboratively in the federated learning process; and
when the new added trainer number is different from the trainer number of the first trainer and the new added trainer number is greater than the trainer number of the first trainer, determine to exit the model training.

13. The electronic device according to claim 10, wherein the processor is further caused to:
query the trainer numbers of the second participant in the counter component, and when no number being the same as the trainer number of the first trainer exists in the trainer numbers of the second participant and a number greater than the trainer number of the first trainer exists in the trainer numbers of the second participant, determine to exit the model training.

14. The electronic device according to claim 10, wherein the processor is further caused to:
query, after taking the second trainer corresponding to the target number as the pairing trainer of the first trainer, an operation event triggered by the second trainer in the counter component through an event query interface, wherein the event query interface is an interface provided by the counter component for query an operation event of a trainer; and
when a number deletion event or a session loss event triggered by the second trainer is queried, determine to exit the model training.

15. The electronic device according to claim 10, wherein when obtaining, after the first trainer is started, the trainer number of the first trainer from the counter component, the processor is further caused to:
send, after the first trainer is started, a registration request to the counter component, so that the counter component takes a registration sequence number of the first trainer as the trainer number of the first trainer in response to the registration request; and
obtain the trainer number of the first trainer from the counter component.

16. The electronic device according to claim 10, wherein a first number list comprising trainer numbers of the first participant and a second number list comprising the trainer numbers of the second participant are stored in the counter component, wherein the trainer numbers of the first participant are determined by the counter component in response to registration requests of trainers of the first participant, and the trainer numbers of the second participant are determined by the counter component in response to registration requests of trainers of the second participant.

17. The electronic device according to claim 16, wherein when querying the trainer numbers of the second participant in the counter component, the processor is further caused to:
query the second number list in the counter component through a number query interface to obtain the trainer numbers of the second participant, wherein the number query interface is an interface provided by the counter component for querying a trainer number.

18. The electronic device according to claim 10, wherein the processor is further caused to:
determine a communication channel based on the trainer number of the first trainer, so as to send a message to the second trainer through the communication channel.

19. A non-transitory computer-readable storage medium storing instructions that cause at least a processor to:
obtain, after a first trainer is started, a trainer number of the first trainer from a counter component; and
query trainer numbers of a second participant in the counter component, and take a second trainer corresponding to a target number as a pairing trainer of the first trainer when the target number being a same as the trainer number of the first trainer exists in the trainer numbers of the second participant,
wherein the first trainer and the second trainer are configured to perform model training collaboratively in a federated learning process, and trainers started by the first participant and the second participant are numbered according to a same rule.

20. The non-transitory computer-readable storage medium according to claim 19, wherein the processor is further caused to:
query the trainer numbers of the second participant in the counter component, and when no number being the same as the trainer number of the first trainer exists in the trainer numbers of the second participant and no number greater than the trainer number of the first trainer exists in the trainer numbers of the second participant, continue to query a new added trainer number of the second participant; and
determine whether to exit the model training according to the new added trainer number.
